(19) United States
(12) Patent Application Publication
(10) Pub. No.: US 2008/0276233 A1
(43) Pub. Date: Nov. 6, 2008

(54) Method And System For Collecting Data to Support Installed Software Applications

(75) Inventors: Allen H. Saxton, Schaumburg, IL (US); Ravneet Grewal, Schaumburg, IL (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Macrovision Corporation

(21) Appl. No.: 11/744,133

(22) Filed: May 3, 2007

(51) Int. Cl. G06F 9/445

(52) U.S. Cl. 717/174

(57) ABSTRACT

A method and system for collecting data to support a software application are disclosed. In one embodiment, the method comprises receiving as an input a software application. Installation data is retrieved from the software application. The method further comprises encoding within the installation data a description of support data to be collected from a user of the software application.

### FIELD OF THE INVENTION

The field of the invention relates generally to computer systems and more particularly relates to a method and system for collecting data to support installed software applications.

### BACKGROUND OF THE INVENTION

Generally, software installations represent certain installation attributes abstractly. One example is the installation attribute, TARGETDIR. Other installation attributes are provided as options to a user during the installation process or as conditions assigned to the installation of various software components. Because of how the installation is constructed, it is difficult to automate software product support as support personnel often do not know what component of a software installation is installed or where such a component is installed on the user's computer system.

As an example, many software products generate data (e.g., some physical changes to the computer system) and/or data files dynamically after the installation process. Software products commonly incorporate logging functionality in which a file is generated by a software product that describes the software product's operations. Many software products have logging functionality which is enabled by a register key and which generates log files at specific locations. Often, support personnel may request that users include these log files in their support requests. The users, however, will need to manually follow a series of instructions to generate and locate the files in order to send them to the support personnel.

To more effectively support software products, some companies construct custom tools to collect data that might be useful to support a specific product. Such tools, however, have certain limitations. First, these tools are custom implementations. Some companies will not have the resources to construct custom tools. Second, these custom tools are often indiscriminate in what data they collect. As a result, support personnel are forced to analyze irrelevant data. Third, custom tools may need to be constantly updated for each product release. This is because the type and location of data to support a product may often vary with each release of the product.

### SUMMARY

A method and system for collecting data to support a software application are disclosed. In one embodiment, the method comprises receiving as an input a software application. Installation data is retrieved from the software application. The method further comprises encoding within the installation data a description of support data to be collected from a user of the software application.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary software installation network, according to one embodiment of the present invention.

FIG. 2 illustrates a block diagram of an exemplary software support integration module, according to one embodiment of the present invention.

FIG. 3 illustrates a block diagram of an exemplary log file, according to one embodiment of the present invention.

FIG. 4 illustrates a flow diagram of an exemplary process of providing support of a software application, according to one embodiment.

FIG. 5 illustrates an exemplary computer architecture for use with the present system, according to one embodiment.

### DETAILED DESCRIPTION

A method and system for collecting data to support a software application are disclosed. In one embodiment, the method comprises receiving as an input an installed software application. Installation data, such as a log file, is retrieved from the installed software application. The method further comprises encoding within the installation data a description of support data to be collected from a user of the software application. The end-user is instructed on how to complete the support request and/or what data is going to be included in the support request.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

According to one embodiment, the following terms may have the following meanings without regard to its upper or lower case usage. However, one of ordinary skill would understand that additional embodiments may contemplate additional terms and/or variation of these terms.

“Installation encoder module” may mean any combination of software, firmware, and/or hardware that encodes a support data description, a user interface description, and/or a logical process within software installation data.

“Installation data retrieval module” may mean any combination of software, firmware, and/or hardware that retrieves installation data from an installed software application.

“Software support integration module” may mean any combination of software, firmware, and/or hardware that receives a software application, collects the necessary support data, and uploads the data to the support personnel.

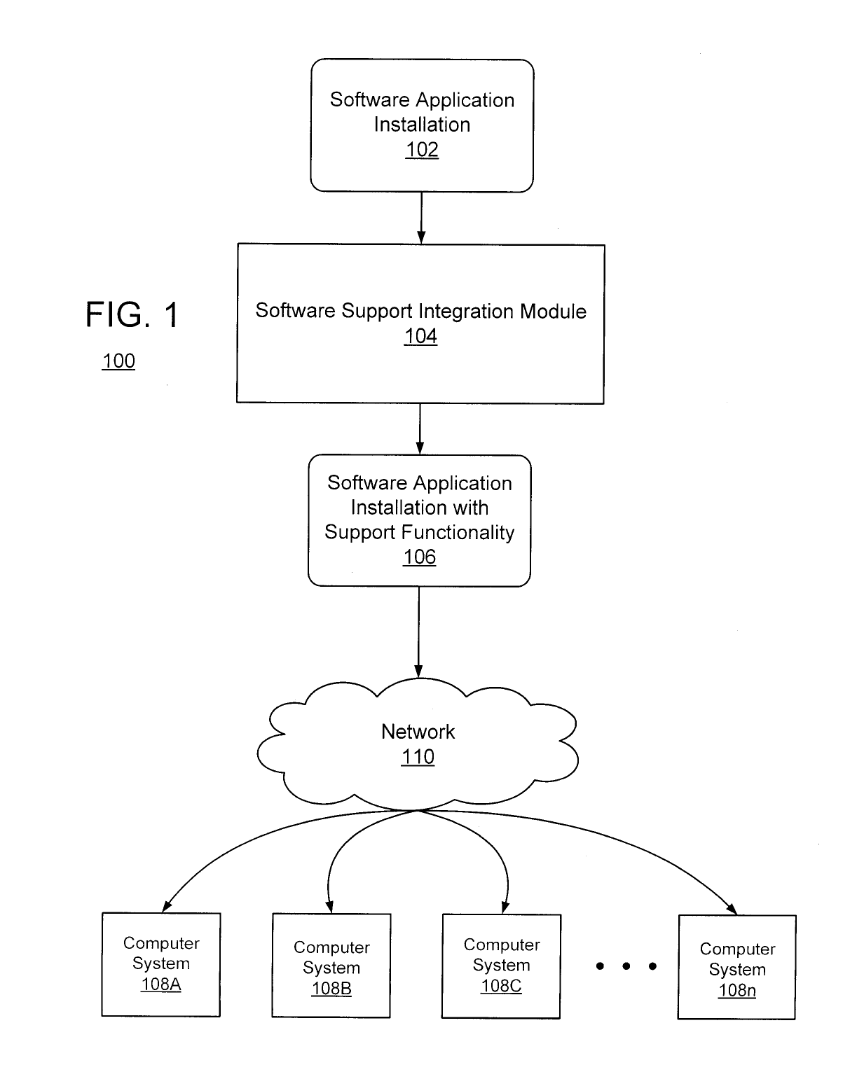

FIGS. 1-3 illustrate block diagrams of an exemplary software installation system according to embodiments of the present invention. In addition to software installation systems, it is to be appreciated that other systems employing the various teachings herein may also be used to practice the various aspects of the present invention, and as such, are considered to be within its full scope.

FIG. 1 illustrates a block diagram of an exemplary software installation network 100 in this exemplary software installation network 100, a software application installation 102 is provided to a software support integration module 104. For example, software support integration module 104 may reside on a computer system of a support personnel who provides customer support for software application installation 102. As another example, software support integration module 104 may reside on a computer system of a software developer who develops software application installation 102 to include automatic support service. Alternatively, software support integration module 104 may reside on a computer system of an installation author.

Software support integration 104 receives software application installation 102 and generates a software application installation 106 with support functionality. In one embodiment of the invention, software application installation 106 with support functionality is distributed to one or more computer systems 108 via a network 1 0. Network 110 may be a local area network (“LAN”), wide area network (“WAN”), virtual private network (“VPN”), or other network, such as the Internet, that is configured to transmit data to or from computer systems 108. In another embodiment of the invention, software application installation 106 with support functionality is distributed to computer systems 108 via computer readable storage media such as floppy disks, magnetic disks, optical disks, etc.

Software application installation 106 with support functionality is installed on one or more computer systems 108. The support functionality enables support personnel to automatically collect information regarding installation of software application installation 106 on computer systems 108. Support personnel thus are able to collect meaningful information regarding how software application installation 106 operates on computer systems 108, without substantial involvement from users of computer systems 108.

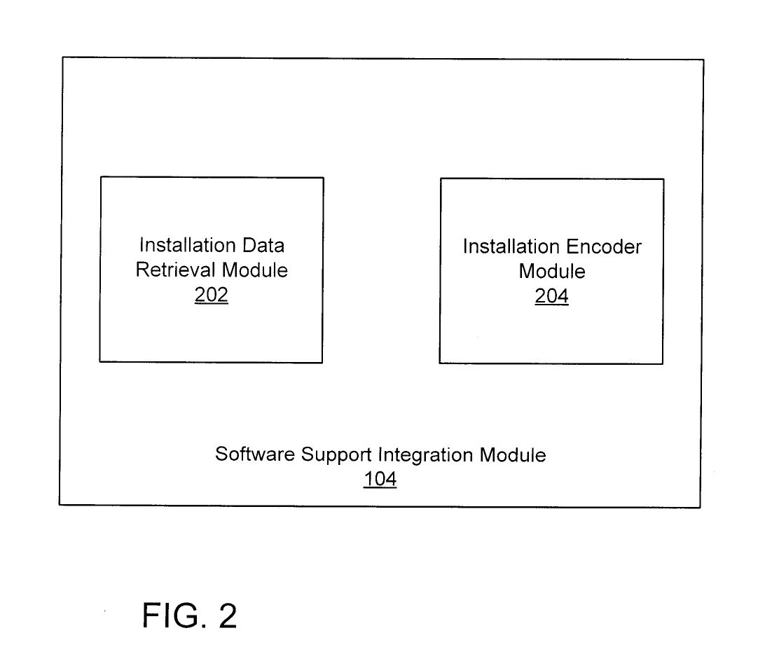

FIG. 2 illustrates a block diagram of software support integration module 104, according to one embodiment of the present invention. As illustrated in FIG. 1, software support integration module 104 is configured to receive software application installation 102 and generate software application installation 106 with support functionality. In one embodiment of the invention, software support integration module 104 includes an installation data retrieval module 202 and an installation encoder module 204. Installation data retrieval module 202 is configured to retrieve installation data, such as a log file, from software application installation 102. Installation encoder module 204 is configured to encode additional data within the installation data to generate software application installation 106 with support functionality. In addition to or lieu of the installation data, software support integration module 104 may also encode additional data in another portion of software application installation 102.

The log file is chosen in one embodiment of the invention because it contains uninstall information of software application installation 106. By analyzing the uninstall information, support personnel can determine specific attributes of the installation such as TARGETDIR. In addition, support personnel can determine the state of one or more computer systems 108. For most Windows and non-Windows software packages, there is an uninstall log file from which support personnel can determine changes made to computer systems 108. Specifically, support personnel can determine such changes by identifying those operations that need to be undone in order to remove a particular software package and inferring those resources and configuration information added or modified by the installation. For Microsoft Installer (“MSI”) based package installations, the uninstall information is contained within the MSI file itself. By analyzing how the MSI engine operates on computer systems 108, support personnel can deduce the state of computer systems 108 at the time when software application installation 106 is installed.

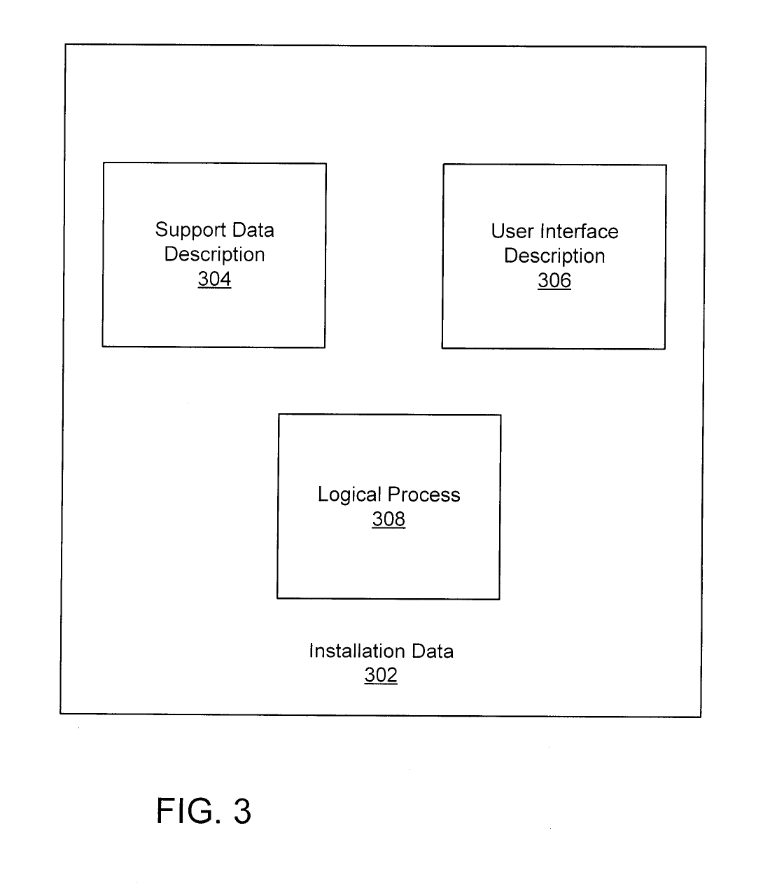

FIG. 3 illustrates a block diagram of exemplary installation data 302 of software application installation 106 after installation encoder module 204 encodes additional data within installation data 302, according to one embodiment of the present invention. As shown, installation data 302 includes support data description 304, user interface description 306, and logical process 308. Support data description 304 contains a description of the software package support data to collect, such as files, registry keys, and other attributes of software application installation 106. In one embodiment of the invention the data to support software application installation 106 may be described as components with a particular identifier that may not be a part of the software installation.

As an example, support personnel may like to know how or if software application installation 106 is used in computer systems 108 in order to manage system resources. To that end, MSI has some underlying technology to collect feature usage statistics. By collecting statistics of how various features of software application installation 106 are used in computer systems 108, support personnel is able to identify when and how software application installation 106 is used in computer systems 108. Accordingly, support data description 304 may include feature usage statistics as a part of its components. Other components of support data description 304 may include, among other things license information regarding software application installation 106.

User interface description 306 contains a description of the user interface to display to a user of computer system 108 during the process of collecting support data. User interface description 306 may be modeled after similar data in the installation as most installations include a user interface experience. The user interface may inform a user of computer system 108 the process which is being performed to collect data and seek the user's assistance if some data collection process cannot be completed automatically.

Logical process 308 contains a description of the logical process to collect support data. In one embodiment of the invention, logical process is configured to automatically collect support data from computer system 108 in response to a user requesting support service for software application installation 106. Logical process 308 may combine the elements of causing the user interface to be displayed to a user, managing the user's response, and setting and retrieving support data. Logical process 308 may be represented using various scripting languages. Any self-describing file format (e.g., extensible markup language (“XML”), Virtual Basic script, or Java script) may be used to represent logical process 308. In one embodiment of the invention, logical process 308 reads data from support data description 304, supports the needs of user interface 306, and completes the support request encoding and uploading.

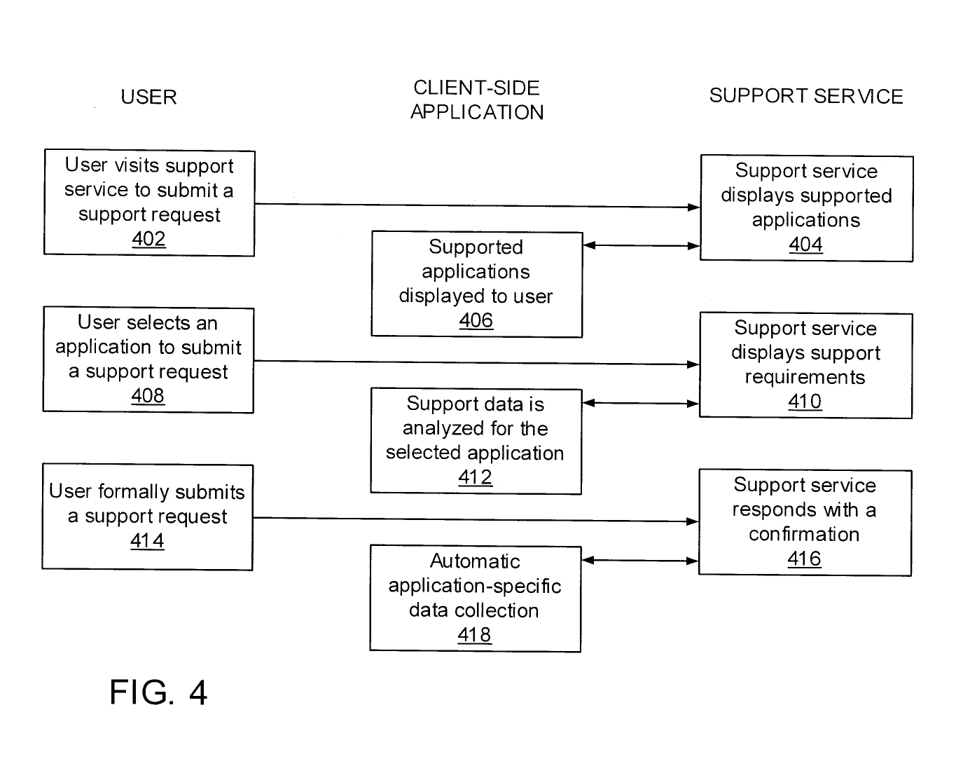

FIG. 4 illustrates a flow diagram of an exemplary process of providing support of a software application, according to one embodiment. In FIG. 4, a user of computer system 108 visits support service (e.g., a website) to submit a support request for one or more software applications. (402) Support service then displays a list of applications that are supported. (404) A client-side application (e.g., installation data 302 including logical process 308) residing on computer system 108 displays the list of supported applications to the user. (406) The user selects one or more of the supported applications to submit a support request. (408) Support service displays application-specific support requirements. (410) The client-side application analyzes support data to be collected for the selected application. (412) In one embodiment of the invention, the support data is encoded in a log file of the selected application. The user follows any instructions of support service and formally submits the support request. (414) Support service responds with a confirmation feedback. (416) The client-side application automatically collects support data for the selected application and provides the collected support data to support service, for example, via the network 110. (418)

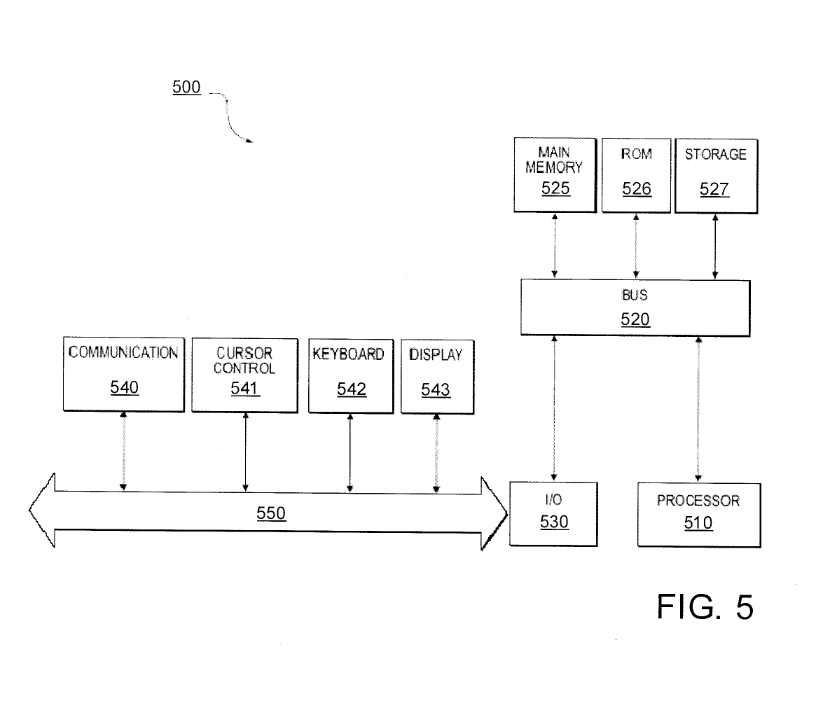

FIG. 5 illustrates an exemplary computer architecture for use with the present system, according to one embodiment. Computer architecture 500 can be used to implement the computer systems described in various embodiments of the invention, including any of the design-time module 202, the information collection module 204, the integration module 206, the storage module 208, the runtime module 210, the application launcher module 302, the information reader module 304, and the hook module 306. One embodiment of architecture 500 comprises a system bus 520 for communicating information, and a processor 510 coupled to bus 520 for processing information. Architecture 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Architecture 500 also may include a read only memory (ROM) and/or other static storage device 526 coupled to bus 520 for storing static information and instructions used by processor 510.

A data storage device 527 such as a magnetic disk or optical disc and its corresponding drive may also be coupled to computer system 500 for storing information and instructions. Architecture 500 can also be coupled to a second I/O bus 550 via an I/O interface 530. A plurality of I/O devices may be coupled to I/O bus 550, including a display device 543, an input device (e.g., an alphanumeric input device 542 and/or a cursor control device 541). For example, web pages and business related information may be presented to the user on the display device 543.

The communication device 540 is for accessing other computers (servers or clients) via a network. The communication device 540 may comprise a modem, a network interface card, a wireless network interface or other well known interface device, such as those used for coupling to Ethernet, token ring, or other types of networks.

Although the present method and system have been described in connection with a software installation system, one of ordinary skill would understand that the techniques described may be used in any situation where it is to collect data to support installed software applications.

A method and system for collecting data to support a software application are disclosed. In one embodiment, the method comprises receiving as an input a software application. Installation data is retrieved from the software application. The method further comprises encoding within the installation data a description of support data to be collected from a user of the software application.

I claim:

1. A computer-implemented method, comprising:
receiving as an input a software application;
retrieving installation data from the software application; and
encoding within the installation data a description of support data to be collected from a user of the software application.

2. The computer-implemented method of claim 1, wherein the installation data includes a log file.

3. The computer-implemented method of claim 1, wherein the installation data includes uninstall information of the software application.

4. The computer-implemented method of claim 1, further comprising:
encoding within the installation data a description of a user interface to be provided to the user during collection of the support data.

5. The computer-implemented method of claim 1, further comprising:
encoding within the installation data a logical process for collecting the support data.

6. The computer-implemented method of claim 5, wherein the logical process is configured to automatically collect the support data from a computer system of the user.

7. The computer-implemented method of claim 5, wherein the logical process is in a self-describing file format.

8. The computer-implemented method of claim 1, wherein the support data includes a description of how one or more features of the software application are used by the user.

9. The computer-implemented method of claim 1, further comprising:
providing the software application encoded with the description of the support data to the user, wherein the software application is installed on a computer system of the user.

10. A computer-readable medium having stored thereon a plurality of instructions, said plurality of instructions when executed by a computer, cause said computer to perform:
receiving as an input a software application;
retrieving installation data from the software application; and
encoding within the installation data a description of support data to be collected from a user of the software application.

11. The computer-readable medium of claim 10, wherein the installation data includes uninstall information of the software application.

12. The computer-readable medium of claim 10, wherein the installation data includes uninstall information of the software application.

13. The computer-readable medium of claim 10, wherein the plurality of instructions cause the computer to perform:
encoding within the installation data a description of a user interface to be provided to the user during collection of the support data.

14. The computer-readable medium of claim 10, wherein the plurality of instructions cause the computer to perform:
encoding within the installation data a logical process for collecting the support data.

15. The computer-readable medium of claim 14, wherein the logical process is configured to automatically collect the support data from a computer system of the user.

16. The computer-readable medium of claim 14, wherein the logical process is in a self-describing file format.

17. The computer-readable medium of claim 10, wherein the support data includes a description of how one or more features of the software application are used by the user.

18. The computer-readable medium of claim 10, wherein the plurality of instructions cause the computer to perform:
providing the software application encoded with the description of the support data to the user, wherein the software application is installed on a computer system of the user.

19. A computer system, comprising:
a processor; and
memory coupled to the processor, the memory storing instructions;
wherein the instructions when executed by the processor cause the processor to:
receive as an input a software application;
retrieve installation data from the software application; and
encode within the installation data a description of support data to be collected from a user of the software application.

20. The computer system of claim 19, wherein the installation data includes uninstall information of the software application.

21. The computer system of claim 19, wherein the installation data includes uninstall information of the software application.

22. The computer system of claim 19, wherein the instructions cause the processor to:
encode within the installation data a description of a user interface to be provided to the user during collection of the support data.

23. The computer system of claim 19, wherein the instructions cause the processor to:
encode within the installation data a logical process for collecting the support data.

24. The computer system of claim 23, wherein the logical process is configured to automatically collect the support data from a computer system of the user.

25. The computer system of claim 23, wherein the logical process is in a self-describing file format.

26. The computer system of claim 19, wherein the support data includes a description of how one or more features of the software application are used by the user.

27. The computer system of claim 19, wherein the instructions cause the processor to:
provide the software application encoded with the description of the support data to the user, wherein the software application is installed on a computer system of the user.
